(19) United States
(12) Patent Application Publication
(10) Pub. No.: US 2026/0351937 A1
(43) Pub. Date: Nov. 5, 2026

(54) ELECTRICAL SUPPLY BOX FOR A FURNACE

(71) Applicant: NSA Products, LLC, Franklin, IN (US)

(72) Inventors: Mark Stansbury, Greenwood, IN (US); Walter Key, Greenwood, IN (US); Mark Key, Indianapolis, IN (US)

(73) Assignee: NSA Products, LLC, Franklin, IN (US)

(21) Appl. No.: 19/668,146

(22) Filed: May 5, 2026

Related U.S. Application Data
(60) Provisional application No. 63/799,850, filed on May 5, 2025.

(51) Int. Cl. H02G 3/08; F24D 19/10; H02G 3/14

(52) U.S. Cl. CPC H02G 3/081; F24D 19/10; H02G 3/14

(57) ABSTRACT

A preassembled electrical supply box for a furnace includes a housing having a plurality of walls defining a housing interior and a cover that is movable with respect to the plurality of walls to allow access to the housing interior. A switch assembly is accessible from outside of the housing. A power inlet fitting is positioned on one of the walls of the housing and allows an incoming power cable to be attached to the housing to provide a power source for the electrical supply box that may be electrically connected to preassembled wiring within the housing. A nipple is positioned on one of the walls of the housing, and wiring that is designed to be electrically connected to the furnace may extend through the nipple and exterior of the housing.

### CROSS-REFERENCE TO RELATED APPLICATION

This application claims the benefit of US Provisional Application No. 63/799,850 filed May. 5, 2025, which is hereby incorporated by reference.

### BACKGROUND OF THE INVENTION

Many electrical codes require that a furnace includes a readily accessible disconnect switch located within sight of the appliance. The accessible switch allows power to the furnace to be isolated so that servicing and maintenance for the furnace can be performed safely. Typically, the installer sources each of the parts required for the disconnect switch and assembles the parts for an electrical supply box when they are installing the disconnect switch at the furnace. This process increases the amount of time needed to install the disconnect switch and the furnace. Therefore, there is need for improvement in this field.

### SUMMARY OF THE INVENTION

A preassembled electrical supply box for a furnace may comprise a housing including a plurality of walls and a cover. The walls and cover may define a housing interior, and the cover may be movable with respect to the walls to allow access to the housing interior. A switch assembly including a switch may be accessible from outside of the housing. In certain embodiments, the switch assembly may be positioned on the cover of the housing. The cover may include a cover recess, and the switch assembly may be received within the cover recess.

A power inlet fitting may be positioned on one of the plurality of walls of the housing and may be aligned with a power inlet fitting opening defined through the housing. The power inlet fitting may be configured to secure an incoming power cable to the housing. A nipple may be positioned on one of the plurality of walls of the housing and may be aligned with a nipple opening defined through the housing. In certain embodiments, the nipple may include an outer threaded surface configured to receive a locknut for securing the housing to a wall of the furnace. The power inlet fitting and/or the nipple may be integral to the housing.

A plurality of outgoing wires may include a load wire, a neutral wire, and a ground wire. At least a portion of each of the plurality of outgoing wires may be positioned within the housing interior and may be electrically connected to the switch assembly. The plurality of outgoing wires may be configured to be electrically connected to a furnace and insertable through the nipple such that an end of each of the plurality of outgoing wires is positioned exterior of the housing. In certain embodiments, the electrical connection of the plurality of outgoing wires to the switch assembly may be made using one of a terminal strip, wire nuts, or lever nut connectors.

In some instances, a terminal strip may be positioned within the housing interior, and the plurality of outgoing wires may be electrically connected to the terminal strip. The terminal strip may be configured to receive wires from the incoming power cable secured to the power inlet fitting. The terminal strip may include a first terminal for a hot wire connection, a second terminal for a neutral wire connection, and a third terminal for a ground wire connection.

In certain embodiments, the switch may include an indicator light electrically connected to the switch. The indicator light may be configured to illuminate when the switch is in an on position and power is supplied to the electrical supply box.

In certain embodiments, adhesive may be positioned on an exterior surface of one of the plurality of walls of the housing. The adhesive may be configured to temporarily secure the housing to a wall of the furnace.

In certain embodiments, an incoming power cable may be secured to the power inlet fitting of the electrical supply box, and the incoming power cable may be electrically connected to a power source exterior to the housing. A furnace having a wall with an opening may receive the nipple of the electrical supply box. The ends of the plurality of outgoing wires exterior to the housing may be electrically connected to wiring within the furnace by at least one electrical connector electrically connecting the ends of the plurality of outgoing wires to the furnace wiring.

A method of installing an electrical supply box on a furnace may comprise drilling a hole through a wall of the furnace. A preassembled electrical supply box may be aligned with the hole. The preassembled electrical supply box may include a housing with a movable cover, a switch assembly, a power inlet fitting on the housing, a nipple on the housing, and a plurality of outgoing wires electrically connected within the housing and extending exteriorly through the nipple. The plurality of outgoing wires may include a load wire, a neutral wire, and a ground wire. The nipple may be inserted through the hole in the wall of the furnace to position the end of each of the plurality of outgoing wires interior to the furnace. The power inlet fitting and the nipple may be integral to the housing of the preassembled electrical supply box.

The electrical supply box may be secured to the wall of the furnace. An incoming power cable may be secured to the power inlet fitting on the housing exterior to the furnace. Wires from the incoming power cable may be electrically connected to internal wiring of the electrical supply box. In certain instances, a source hot wire, a source neutral wire, and a source ground wire may be connected to a terminal strip within a housing interior of the electrical supply box. In other examples, the source hot wire, source neutral wire, and source ground wire may be connected to the internal wiring of the electrical supply box with wire nuts, quick connect electrical connectors, lever nut connectors, or any other suitable form of electrical connector. The ends of the plurality of outgoing wires may be electrically connected to the wiring of the furnace.

In certain embodiments, the electrical supply box may be at least initially secured to the wall of the furnace using adhesive on an exterior surface of the housing prior to threading the locknut. The electrical supply box may then be secured to the wall of the furnace by threading a locknut onto an outer threaded surface of the nipple interior to the furnace. In other embodiments, the locknut may be snapped on to the outer surface of the nipple or secured to the locknut in another suitable method.

Further objects, features and advantages of the present invention shall become apparent from the detailed drawings and descriptions provided herein. Each embodiment described is not intended to address every object described herein, and each embodiment does not include each feature described. Some or all of these features may be present in the corresponding independent or dependent claims, but should not be construed to be a limitation unless expressly recited in a particular claim.

### BRIEF DESCRIPTION OF THE DRAWINGS

FIG. 1 is a front perspective view of a preassembled electrical supply box for a furnace.

FIG. 2 is a front perspective view of a housing of the preassembled electrical supply box of FIG. 1.

FIG. 3 is a rear perspective view of the housing of FIG. 2.

FIG. 4 is a front perspective view of a cover of the preassembled electrical supply box of FIG. 1.

FIG. 5 is a side cross-sectional view of the cover of FIG. 4.

FIG. 6 is a front perspective view of the preassembled electrical supply box of FIG. 1 with the cover opened.

FIG. 7 is a front perspective view of the preassembled electrical supply box of FIG. 6 with an incoming power cable attached.

FIG. 8 is a diagrammatic view of the electrical supply box of FIG. 1 electrically attached to a power source and to a furnace.

FIG. 9 is a flow chart illustrating a method of installing the preassembled electrical supply box on a furnace.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

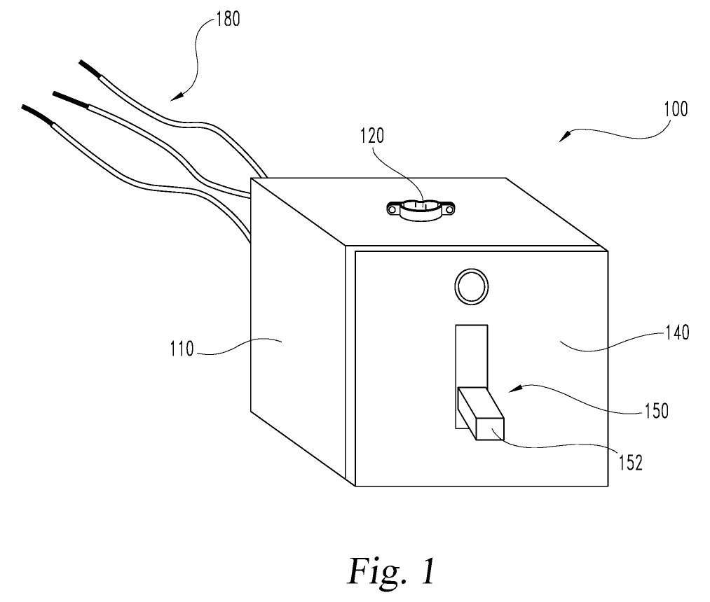

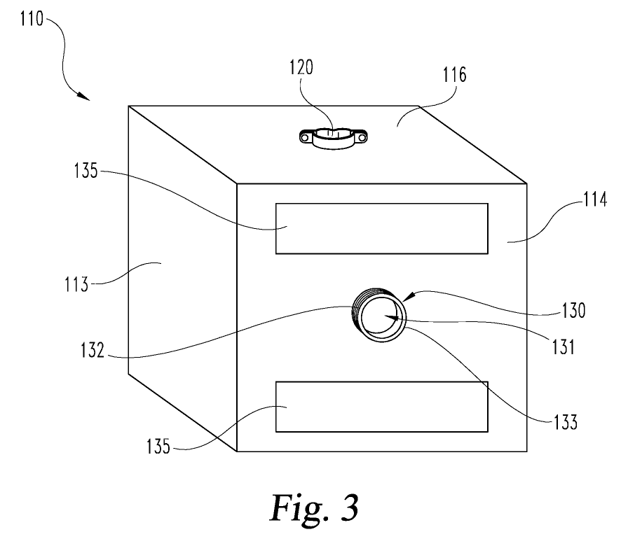

A front perspective view of an electrical supply box 100 for a furnace is shown in FIG. 1. The electrical supply box 100 is at least partially preassembled to aid with installation at a furnace. The electrical supply box 100 includes a housing 110 and a cover 140 that is attached to the housing 110. The cover 140 may be removably attached to the housing 110 and/or may be hinged with respect to the housing 110 to allow access to an interior of the housing 110. A switch assembly 150 includes a switch 152 that extends from the cover 140. A power inlet fitting 120 is positioned on a surface of the housing 110 for securing an incoming power cable from a power supply to the housing 110. Outgoing wires 180 from the electrical supply box extend through a nipple 130 (see FIG. 3) and exterior of the housing 110 to allow connection to a furnace power supply.

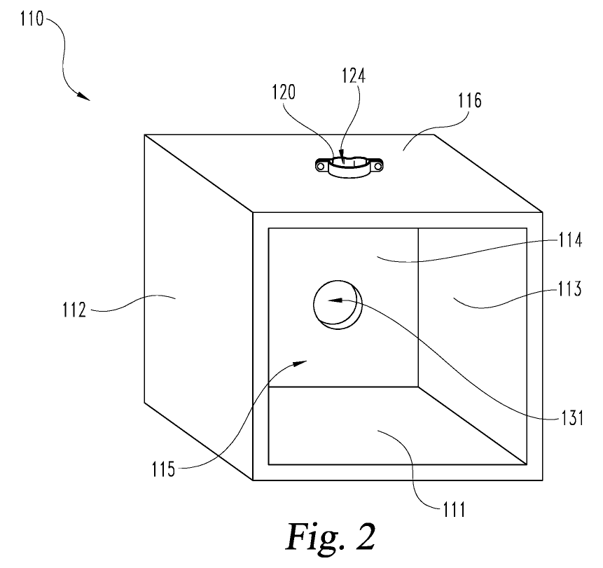

FIG. 2 shows a front perspective view of the housing 110 of electrical supply box 100 and FIG. 3 shows a rear perspective view of the housing 110. The housing 110 includes a base wall 111, sidewalls 112, 113 extending from the base 111, a rear wall 114 positioned between the sidewalls 112, 113, and a top wall 116. A housing interior 115 is defined by the walls 111, 112, 113, 114, 116 of the housing 110 and provides space for electrical components to be stored within the housing 110. The housing interior 115 is accessed from the front of the housing 110, where there is no housing wall.

A power inlet fitting 120 is positioned on the top wall 116 of the housing 110. The power inlet fitting 120 may be any desired style of fitting for securing an incoming power cable to the housing 110. As an example, the power inlet fitting 120 may be an armored cable fitting, a conduit hub or coupling for electrical metallic tubing (EMT) or rigid metal conduit (RMC), an NM cable clamp for non-metallic sheathed cable, or a strain relief connector for flexible cord or liquid tight flexible conduit. In each case, the power inlet fitting 120 is aligned with a power inlet opening 124 defined through the housing 110 to allow wires from the incoming power cable to enter the housing interior 115.

In some particular embodiments, the power inlet fitting 120 may be an armored cable fitting that may include a clamp that may be tightened, using screws or other suitable methods, to secure an armored cable to the housing 110 at the power inlet fitting 120. In some embodiments, the power inlet fitting 120 may be formed as a monolithic component of the housing 110, so that the power inlet fitting 120 is integral to the housing 110. However, in other embodiments, the power inlet fitting 120 may be attachable and removable from the housing 110.

In some embodiments, the power inlet fitting 120 may be positioned on other walls of the housing other than the top wall 116. As an example, the power inlet fitting 120 may be positioned on sidewall 112 or sidewall 113, or the power inlet fitting 120 may be positioned on base wall 111. In other embodiments, the housing 110 may include multiple power inlet fittings 120. In some examples, top wall 116 may include two or more power inlet fittings 120. In other embodiments, the multiple power inlet fittings 120 may be positioned on different walls. As an example, a first power inlet fitting 120 may be positioned on the top wall 116 while a second power inlet fitting may be positioned on the base wall 111.

As shown in FIG. 3, a nipple 130 extends from the rear wall 114 of the housing 110. The nipple 130 defines a nipple opening 131 that extends through the rear wall 114 and allows access into the housing interior 115. An outer surface 132 of the nipple 130 may be threaded, so that a threaded component may be attached at the nipple 130. As an example, a locknut may be threaded onto the outer surface 132 of the nipple 130 to assist secure the housing 110 to a wall of a furnace. In some examples, an inner surface 133 of the nipple 130 is smooth, so that wiring passed from the housing interior 115 through the nipple opening 131 does not get snagged or damaged. In some embodiments, the nipple 130 may be formed as a monolithic component of the housing 110, so that the nipple 130 is integral to the housing 110. However, in other embodiments, the nipple 130 may be attachable and removable from the housing 110.

In other embodiments, the nipple 130 may be configured for snap-fit attachment to the furnace wall, such as by including one or more resilient clips, barbs, or interference features on the outer surface 132 that engage with a corresponding hole or slot in the furnace wall upon insertion, providing a quick and tool-free securement without the need for additional fasteners. Alternative attachment methods may also be employed depending on the furnace configuration and installation requirements. For example, the housing 110 may include integral flanges or mounting ears adjacent to the nipple 130 that receive screws or bolts threaded into the furnace wall. In some embodiments, the nipple 130 and the nipple opening 131 may be defined on any of the other walls 111, 112, 113, 116 of the housing 110 as desired.

In certain embodiments, the housing 110 may include additional nipples 130 so that multiple nipples 130 are positioned on the same wall of the housing 110 or so that multiple walls of the housing 110 have nipples 130.

Also shown in FIG. 3, in some embodiments, the rear wall 114 of the housing 110 may include adhesive 135 to assist with at least temporarily securing the housing 110 to a surface of the wall of the furnace on which the electrical supply box 100 is being installed. The temporary securement of the electrical supply box 100 on the desired surface assists an installer with installation of the electrical supply box 100 until the electrical supply box 100 is permanently secured.

Although the adhesive 135 is shown as two strips in the embodiment shown in FIG. 3, other embodiments may provide adhesive 135 in different arrangements. For example, the adhesive 135 may be present on the entire surface of the rear wall 114. In other examples, the adhesive 135 may be located at the four corners of the rear wall 114. Additionally, it should be recognized that the adhesive 135 may be provided with a protective layer that is removed before securing the rear wall 114 to the desired surface to prevent accidental adhesion at an undesired location.

In other embodiments, the adhesive may be present on other surfaces of the housing 110, as desired. As an example, it may be desirable to mount the electrical supply box 100 to a furnace at one of the sidewalls 112, 113 of the housing. In this case, the adhesive 135 may be positioned on sidewall 112 or sidewall 113. In other embodiments, multiple surfaces of the housing 110 may include adhesive 135.

In addition to the power inlet fitting 120 and the nipple 130, in some embodiments, the housing 110 may also include one or more punch outs, on any of the 111, 112, 113, 114, 116 of the housing 110 to provide further customization of the electrical supply box 100. The punch outs may be used to connect additional components to the electrical supply box 100, or to provide additional openings in the housing 110 to feed a conduit through to allow for additional wires to be fed into or out of the electrical supply box 100.

In some embodiments, the housing 110 may be made from metal, such as aluminum or steel. In certain instances, the housing 110 may be formed as a unitary structure, including the power inlet fitting 120 and the nipple 130. In these examples, the housing 110 may be made by casting or another suitable process. In other embodiments, the housing 110 may be made from a plastic, fiberglass, or an elastomer, such as polypropylene, polycarbonate, or another suitable material. In certain instances, the housing 110 may be formed as a unitary structure that includes each of the walls and the power inlet fitting 120 and the nipple 130. In one example, the housing 110 may be formed by molding, but in other embodiments, the housing 110 may be formed by any other suitable process for a forming a unitary structure.

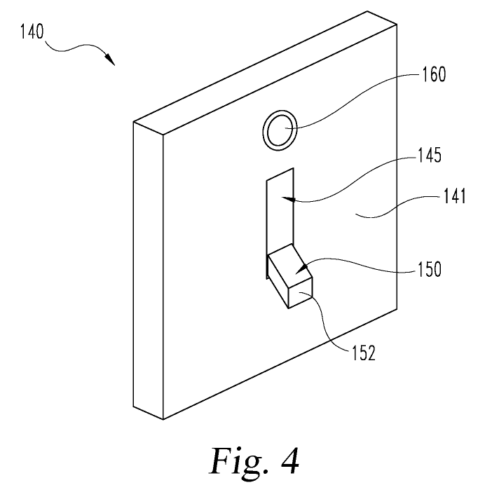

A front perspective view of the cover 140 of the electrical supply box 100 is shown in FIG. 4. The cover 140 includes a cover housing 141. The cover housing 141 is shaped to be positioned with respect to the housing 110 of the electrical supply box to cover the housing interior 115. A cover opening 145 is defined through a surface of the cover housing 141 to allow access to a cover interior. The cover 140 may also include a switch assembly 150 that includes a switch 152 that extends from the cover opening 145. In the embodiment shown, the switch 152 is a toggle switch, but in other embodiments, other suitable varieties of switches may be used, such as a push button, slide, or rotary switch.

In certain embodiments, the cover 140 includes an indicator light 160 that is electrically connected to the switch assembly 150. When the switch is arranged in an on position and power is supplied from a power source, the indicator light 160 is illuminated to signal that the power is on. When the switch is arranged in an off position, or power is not supplied from a power source, then the indicator light 160 is not illuminated, indicating that there is no power.

The cover 140 is attached to the housing 110 to allow access to the housing interior 115 and the components within the housing interior 115. In some embodiments, the cover 140 is hinged to the housing 110, so that the cover 140 may be pivoted with respect to the housing 110 for access to the housing interior 115. In other embodiments, the cover 140 may be removably attached to the housing 110 with a snap fit. Other embodiments may include other suitable methods of attaching the cover 140 to the housing 110 so that a user may access the housing interior 115. This feature allows the cover 140 and the switch assembly 150 to be moved out of the way while working with the electrical supply box 100 to allow more space for a user to access the components within the housing interior 115.

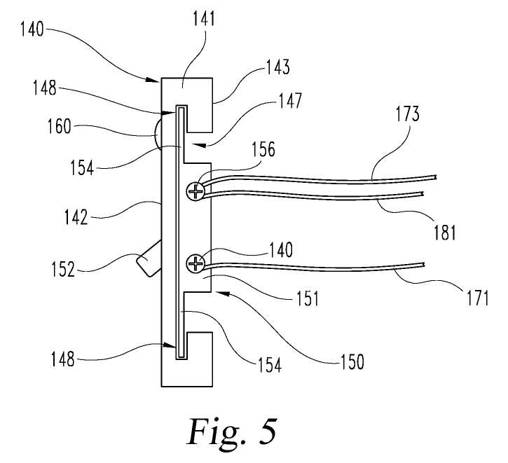

A side cross-sectional view of the cover 140 with the switch assembly 150 is shown in FIG. 5. The cover housing 141 includes a cover front wall 142 and a cover rear wall 143. A cover recess 147 for receiving the switch assembly 150 is defined through the cover rear wall 143, allowing the switch assembly 150 to be incorporated into the cover 140. In the embodiment shown, the cover recess 147 includes a cover recess notch 148 where the width of cover recess 147 at the cover recess notch 148 is greater than the width of the cover recess 147 at other portions of the cover recess 147.

In the embodiments shown, the switch assembly 150 is a single pole, single throw switch, but in other embodiments, other suitable variety of switches may be used. The switch assembly 150 includes a switch base 151 and a switch 152 that extends from the switch base 151 and through the cover opening 145 of the cover housing 141. The switch base 151 includes switch arms 154 that are positionable within the cover recess notch 148 to assist to retain the switch assembly 150 to the cover 140. In some embodiments the switch arms 154 have some elasticity or flexibility that allows the switch arms 154 to be positioned within the cover recess notch 148 and retained within the cover housing 141.

The switch base 151 also includes terminals 156 to provide an electrical connection point for incoming wiring and outgoing wiring. In the embodiment shown, one of the terminals 156 is connected to a switch line wire 171 that provides incoming power from a power source. Another of the terminals 156 is connected to a load wire 181 that is extended outside of the electrical supply box 100 to provide power to the furnace. A separate terminal 156 (positioned on the opposite side of the switch base 151) is connected to a switch ground wire 173.

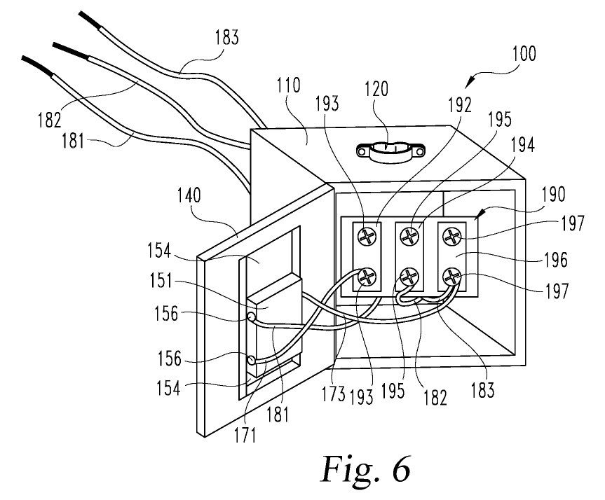

FIG. 6 shows the preassembled electrical supply box 100 with the cover 140 opened to show the components and the wiring within the electrical supply box 100. In the embodiment shown in FIG. 6, the electrical supply box 100 includes a terminal strip 190 that is positioned within the housing interior 115 of the electrical supply box 100. The terminal strip 190 includes a first terminal 192, a second terminal 194, and a third terminal 196. The first terminal 192 includes first terminal screws 193 for securing and electrically connecting wires at the first terminal 192. The second terminal 194 includes second terminal screws 195 for securing and electrically connecting wires at the second terminal 194. The third terminal 196 includes third terminal screws 197 for securing and electrically connecting wires at the third terminal 196.

For the embodiment shown, the first terminal 192 is used for hot wire. The second terminal 194 of the terminal strip 190 is used for neutral wire. The third terminal 196 is used for ground. However, in other embodiments, the function of the terminals at the terminal strip 190 may be changed as desired. For example, the first terminal 192 may be used for ground, while the second terminal 194 is used for hot wire, and the third terminal 196 is used for neutral.

The switch assembly 150 is prewired to the terminal strip 190 and outgoing wires from the terminal strip 190 and the switch assembly 150 are prearranged to reduce installation time at a furnace. A first end of the switch line wire 171 from the switch assembly 150 is connected to the first terminal 192, while a second end of the switch line wire 171 is connected to one of the terminals 156 at the switch assembly 150. A first end of the load wire 181 is connected to another one of the terminals 156 at the switch assembly 150. The load wire 181 is inserted through the nipple opening 131 so that a second end of the load wire 181 is exterior of the electrical supply box 100, allowing the load wire 181 to be electrically connected to the furnace.

A neutral wire 182 is electrically connected at the second terminal 194 of the terminal strip 190. A first end of the neutral wire 182 is connected to a second terminal screw 195, and the neutral wire is inserted through the nipple opening 131 so that a second end of the neutral wire 182 is exterior of the electrical supply box 100, allowing the neutral wire 182 to be electrically connected to the furnace.

For the ground connection, a first end of the switch ground wire 173 is connected to a terminal on the switch assembly 150. A second end of the switch ground wire 173 is connected to the third terminal 196 of the terminal strip 190. A junction ground wire 183 includes a first end that is connected to the third terminal 196 of the terminal strip 190 and is inserted through the nipple opening 131 so that a second end of the junction ground wire 183 is exterior of the electrical supply box 100, allowing the junction ground wire 183 to be connected to the furnace.

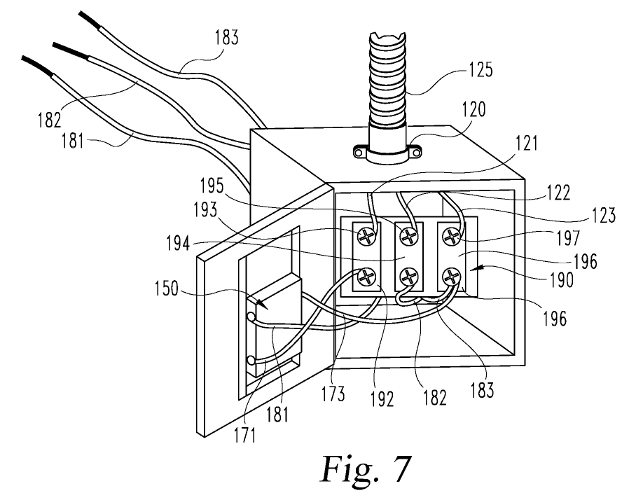

FIG. 7 illustrates the preassembled electrical supply box 100 shown in FIG. 6 with an incoming power cable 125 connected to the electrical supply box 100 to provide line power to the electrical supply box 100. The incoming power cable 125 is secured to the electrical supply box 100 at the power inlet fitting 120. The incoming power cable 125 includes a source hot wire 121, a source neutral wire 122, and a source ground wire 123. The source hot wire 121 is electrically connected to the first terminal 192 at one of the first terminal screws 193. The source neutral wire 122 is electrically connected to the second terminal 194 at one of the second terminal screws 195. The source ground wire 123 is electrically connected to the third terminal 196 at one of the third terminal screws 197.

In some embodiments, the incoming power cable 125 is an armored cable. However, in other embodiments, other types of power cables may be used. For example, the incoming power cable may be electrical metallic tubing (EMT) or rigid metal conduit (RMC) with individual wires pulled therethrough, flexible metal conduit (FMC) or liquid tight flexible nonmetallic conduit (LFNC) enclosing the power wires, non-metallic sheathed cable (NM or Romex), or underground feeder (UF) cable.

Although electrical supply box 100 is shown with the terminal strip 190 to electrically connect the necessary wires from the incoming power cable 125, the switch assembly 150, and the outgoing wires 180, it should be recognized that in other embodiments, other suitable methods of electrically connecting wires may be used. For example, in certain embodiments, the electrical supply box 100 may come preassembled with wire nuts to make the desired electrical connections. In these examples, the installer could use the wire nuts or quick connect electrical connectors to electrically connect the incoming source wires from the incoming power cable 125 to the outgoing wires 180 and the wiring from the switch assembly 150. In other embodiments, the preassembled electrical supply box 100 may use a lever nut-style connector, such as a WAGO® connector, to create the necessary connections between wires.

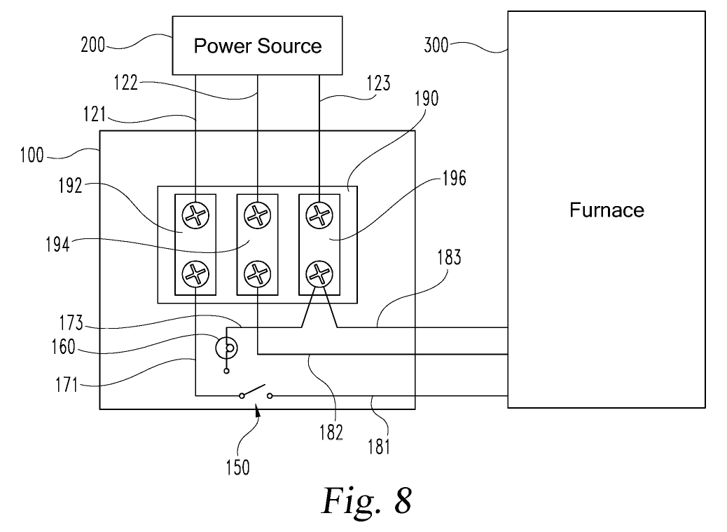

FIG. 8 illustrates a circuit diagram showing the preassembled electrical supply box 100 that is described in FIG. 7 installed to a furnace 300. Power is supplied to the electrical supply box 100 by the power source 200. As described above, the power source 200 supplies a source hot wire 121, a source neutral wire 122, and a source ground wire 123, each of which are connected to the terminal strip 190 at a respective terminal 192, 194, 196. The outgoing wires 180 from the electrical supply box 100 are electrically connected to the furnace 300 to provide power to the furnace 300. The electrical supply box 100 is positioned exterior to the furnace, and typically positioned within sight of the furnace to comply with electrical code. The switch assembly 150 of the electrical supply box 100 may be operated to provide power to the furnace 300 or to turn off power to the furnace 300.

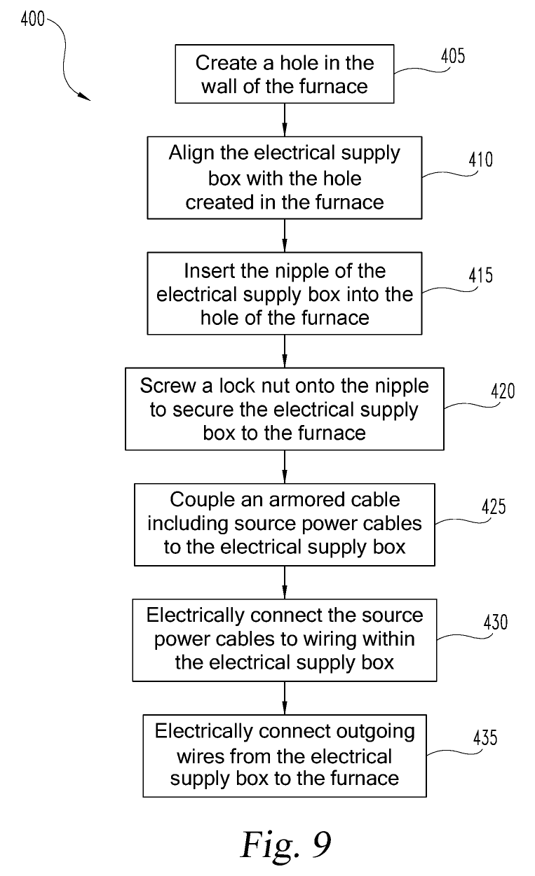

A method of installing the electrical supply box 100 is shown in the flowchart 400 of FIG. 9. Because the electrical supply box 100 is preassembled and prewired, there is no need for a furnace installer to source each of the individual parts of the electrical supply box 100. Instead, the installer is able to bring the preassembled electrical supply box 100 to the location of the furnace. At a first stage 405, the installer drills a hole through a wall of the furnace 300 at the position at which the installer would like to mount the electrical supply box 100 to the furnace. At a second stage 410, the installer aligns the electrical supply box 100 with the hole drilled in the furnace 300, so that nipple 130 is insertable through the hole in the furnace 300. At a third stage 415, the nipple is inserted into the hole created in the furnace. In some embodiments where the housing 110 of the electrical supply box 100 includes the adhesive 135, the adhesive 135 on the housing of the 110 of the electrical supply box 100 at least temporarily supports the electrical supply box 100 on the furnace 300. In a fourth stage 420, a lock nut may then be screwed onto the nipple 130 within the interior of the furnace to further secure the electrical supply box 100 to the furnace 300. However, in other embodiments, rather than a lock nut being screwed onto the nipple 130, the nipple 130 may be snap fit into the hole in the furnace.

In a fifth stage 425, an incoming power cable 125 including the source power wires is coupled to the electrical supply box 100 at the power inlet fitting 120. In a sixth stage 430, each of the wires from the incoming power cable 125 are electrically connected to the appropriate wires already prewired within the electrical supply box 100. The source hot wire 121 is electrically connected to the switch line wire 171, the source neutral wire 122 is electrically connected to the neutral wire 182, and the source ground wire 123 is electrically connected to the switch ground wire 173 and the junction ground wire 183. In some embodiments, the wires are electrically connected at a terminal strip 190. However, in other embodiments, other suitable methods of electrical attachment may be used, such as wire nuts or WAGO® connectors.

In a seventh stage 435, the outgoing wires 180 from the electrical supply box 100 are electrically connected to the appropriate wires at the furnace 300. The outgoing wires include the load wire 181, the neutral wire 182, and the junction ground wire 183. These wires may be electrically connected to the appropriate wires at the furnace 300 using wire nuts, a terminal strip, quick connect electrical connectors, lever nut connectors, or any other suitable method of electrical connection.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as "up", "down", "top" "bottom", "fore", "aft", "lateral", "longitudinal", "radial", "circumferential", etc., are used herein solely for the convenience of the reader in order to aid in the reader’s understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster’s and Random House dictionaries. As used herein, the following definitions apply to the following terms or to common variations thereof (e.g., singular/plural forms, past/present tenses, etc.):
“About” with reference to numerical values generally refers to plus or minus 10% of the stated value. For example, if the stated value is 4.375, then use of the term “about 4.375” generally means a range between 3.9375 and 4.8125.
“And/or” is inclusive here, meaning “and” as well as “or”. For example, “P and/or Q” encompasses, P, Q, and P with Q; and, such “P and/or Q” may include other elements as well.
“Cable” generally refers to one or more elongate strands of material that may be used to carry electromagnetic or electrical energy. A metallic or other electrically conductive material may be used to carry electric current. In another example, strands of glass, acrylic, or other substantially transparent material may be included in a cable for carrying light such as in a fiber-optic cable. A cable may include connectors at each end of the elongate strands for connecting to other cables to provide additional length. A cable is generally synonymous with a node in an electrical circuit and provides connectivity between elements in a circuit but does not include circuit elements. Any voltage drop across a cable is therefore a function of the overall resistance of the material used.

A cable may include a sheath or layer surrounding the cable with electrically non-conductive material to electrically insulate the cable from inadvertently electrically connecting with other conductive material adjacent the cable.

A cable may include multiple individual component cables, wires, or strands, each with, or without, a non-conductive sheathing. A cable may also include a non-conductive sheath or layer around the conductive material, as well as one or more layers of conductive shielding material around the non-conductive sheath to capture stray electromagnetic energy that may be transmitted by electromagnet signals traveling along the conductive material of the cable, and to insulate the cable from stray electromagnetic energy that may be present in the environment the cable is passing through. Examples of cables include twisted pair cable, coaxial cable, “twin-lead”, fiber-optic cable, hybrid optical and electrical cable, ribbon cables with multiple side-by-side wires, and the like.

“Current” generally refers to the rate of flow of electric charge past a point or region. An electric current is said to exist when there is a net flow of electric charge through a region. When an electric current flows in a suitably shaped conductor at radio frequencies, radio waves can be generated. These travel at about the speed of light and can cause electric currents in distant conductors. Electric currents cause Joule heating, and may be useful for creating magnetic fields.

“Electrically connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Ground” or “circuit ground” generally refers to a node in an electrical circuit that is designated as a reference node for other nodes in a circuit. It is a reference point in an electrical circuit from which voltages are measured, a common return path for electric current, and/or a direct physical connection to the Earth.

“Ground cable” generally refers to a cable electrically connecting to a circuit ground.

“Multiple” as used herein is synonymous with the term “plurality” and refers to more than one, or by extension, two or more.

“Nipple” generally refers to a short, tubular fitting or protrusion extending from a wall of an electrical enclosure, configured to provide a protected opening or passage for electrical wires to enter or exit the enclosure interior while facilitating secure attachment of the enclosure to adjacent structures, such as a furnace wall. The nipple may be formed integrally with the housing as a monolithic component (e.g., by molding, casting, or other manufacturing processes) and may include features such as a threaded outer surface for receiving a locknut, a smooth inner surface to prevent wire damage, or other variations. As an example, the nipple may be a chase nipple for routing wires through barriers or other suitable types configured for snap-fit, flanged, or alternative attachment methods depending on the installation requirements.

“Optionally” as used herein means discretionary; not required; possible, but not compulsory; left to personal choice.

“Predominately” as used herein is synonymous with greater than 50%.

“Portion” means a part of a whole, either separated from or integrated with it.

“Power Cable” generally refers to a cable configured to transfer electrical power as part of an electrical circuit. A power cable may be used exclusively to transfer power, or it may be used to also transfer signals defining data.

“Power inlet fitting” generally refers to a connector or hub positioned on a wall of an electrical enclosure, configured to securely attach an incoming power cable to the enclosure and align with an opening in the wall to allow wires from the power cable to enter the enclosure interior for electrical connection to internal components. The power inlet fitting may be formed integrally with the housing as a monolithic component (e.g., by molding or casting) or as a separate attachable element, and may include clamping, threading, or strain relief features to accommodate different cable types; for example, the power inlet fitting may be a BX fitting for securing armored cable, a conduit hub or coupling for electrical metallic tubing (EMT) or rigid metal conduit (RMC), an NM cable clamp for non-metallic sheathed cable, a strain relief connector for flexible cord or liquid-tight flexible conduit, or any other suitable fitting for connecting power to the electrical box depending on the installation requirements and electrical codes.

### Numbered Clauses

1. An electrical supply box for a furnace.

2. The electrical box of any preceding clause, comprising: a housing including a plurality of walls defining a housing interior.

3. The electrical box of any preceding clause, comprising: a cover that is movable with respect to the plurality of walls to allow access to said housing interior.

4. The electrical box of any preceding clause, comprising: a switch assembly.

5. The electrical box of any preceding clause, comprising: a switch assembly that is accessible from outside of said housing.

6. The electrical box of any preceding clause, comprising: a switch assembly that extends from or through a cover.

7. The electrical box of any preceding clause, comprising a housing interior defined by walls of the housing that is accessible from a front side of the housing.

8. The electrical box of any preceding clause, comprising: a power inlet fitting positioned on one of the plurality of walls of a housing.

9. The electrical box of any preceding clause, comprising: a power inlet fitting aligned with an opening defined through a housing.

10. The electrical box of any preceding clause, comprising: a power inlet fitting configured to secure an incoming power cable to a housing.

11. The electrical box of any preceding clause, comprising: a nipple positioned on one of the plurality of walls of a housing.

12. The electrical box of any preceding clause, comprising: a base wall, sidewalls, a rear wall, and a top wall.

13. The electrical box of any preceding clause, comprising: a nipple aligned with a nipple opening defined by a housing.

14. The electrical box of any preceding clause, comprising: a nipple on a rear wall of a housing providing access to the housing through a nipple opening.

15. The electrical box of any preceding clause, comprising: a nipple that is optionally monolithic and/or attachable/removable.

16. The electrical box of any preceding clause, comprising: a plurality of outgoing wires including a load wire, a neutral wire, and a ground wire.

17. The electrical box of any preceding clause, comprising: multiple outgoing wires, wherein at least a portion of each of the outgoing wires is positioned within a housing interior.

18. The electrical box of any preceding clause, comprising: multiple outgoing wires, wherein the outgoing wires are configured to be electrically connected to a furnace.

19. The electrical box of any preceding clause, comprising: multiple outgoing wires, wherein the outgoing wires are configured to be insertable though a nipple so that an end of each of the outgoing wires is positioned exterior of a housing.

20. The electrical box of any preceding clause, wherein the electrical supply box is at least partially preassembled.

21. The electrical box of any preceding clause, comprising: a cover that is removably attached or hinged to a housing for easy access.

22. The electrical box of any preceding clause, comprising: a power inlet fitting that includes a clamp, wherein the clamp is optionally monolithic and/or attachable/removable.

23. The electrical box of any preceding clause, comprising: adhesive on a rear wall of a housing to provide temporary securement during installation.

24. The electrical box of any preceding clause, comprising: adhesive on the electrical box selectively arrangeable in any suitable configuration on a housing of the electrical box.

25. The electrical box of any preceding clause, comprising: a housing that defines punch outs selectively removable to provide access to the housing.

26. The electrical box of any preceding clause, comprising: a housing that includes metal or plastic in its construction.

27. The electrical box of any preceding clause, comprising: a housing that is a single unitary structure.

28. The electrical box of any preceding clause, comprising: a cover that includes a cover housing with a cover opening for access.

29. The electrical box of any preceding clause, comprising: a cover that optionally includes an indicator light connected to a switch assembly in a housing.

30. The electrical box of any preceding clause, comprising: a cover that is coupled to a housing by a hinge.

31. The electrical box of any preceding clause, comprising: a cover that is removably coupled or attached to the housing.

32. The electrical box of any preceding clause, comprising: a switch assembly that optionally includes a switch base with terminals for making electrical connections to the switch.

33. The electrical box of any preceding clause, comprising: a terminal strip with terminals positioned within the interior of a housing.

34. The electrical box of any preceding clause, comprising: a switch assembly and a terminal strip that are optionally prewired to reduce installation time.

35. The electrical box of any preceding clause, wherein an incoming power cable provides line power to the electrical supply box.

36. The electrical box of any preceding clause, wherein an incoming power cable providing power to the electrical box includes a source hot wire, a source neutral wire, and a source ground wire.

37. The electrical box of any preceding clause, wherein the electrical supply box is positioned exterior to a furnace, optionally within sight of the furnace.

38. The electrical box of any preceding clause, wherein the switch assembly is operable, or is configured, to selectively electrically connect and/or disconnect power to the furnace.

39. The electrical box of any preceding clause, wherein the incoming power cable is an armored power cable.

40. The electrical box of any preceding clause, wherein the power inlet fitting is an armored cable fitting.

1. A preassembled electrical supply box for a furnace, comprising:
a housing including a plurality of walls and a cover, the walls and cover defining a housing interior, the cover being movable with respect to the walls to allow access to the housing interior;
a switch assembly including a switch accessible from outside of the housing;
a power inlet fitting positioned on one of the plurality of walls of the housing and aligned with a power inlet fitting opening defined through the housing, the power inlet fitting configured to secure an incoming power cable to the housing;
a nipple positioned on one of the plurality of walls of the housing and aligned with a nipple opening defined through the housing; and
a plurality of outgoing wires including a load wire, a neutral wire, and a ground wire, at least a portion of each of the plurality of outgoing wires positioned within the housing interior and electrically connected to the switch assembly, the plurality of outgoing wires configured to be electrically connected to a furnace and insertable through the nipple such that an end of each of the plurality of outgoing wires is positioned exterior of the housing.

2. The electrical supply box of claim 1, further comprising a terminal strip positioned within the housing interior, wherein the plurality of outgoing wires are electrically connected to the terminal strip, and wherein the terminal strip is configured to receive wires from the incoming power cable secured to the power inlet fitting.

3. The electrical supply box of claim 2, wherein the terminal strip includes a first terminal for a hot wire connection, a second terminal for a neutral wire connection, and a third terminal for a ground wire connection.

4. The electrical supply box of claim 1, wherein the switch assembly further includes an indicator light electrically connected to the switch and configured to illuminate when the switch is in an on position and power is supplied to the electrical supply box.

5. The electrical supply box of claim 1, wherein the nipple includes an outer threaded surface configured to receive a locknut for securing the housing to a wall of the furnace.

6. The electrical supply box of claim 1, further comprising adhesive positioned on an exterior surface of one of the plurality of walls of the housing, the adhesive configured to temporarily secure the housing to a wall of the furnace.

7. The electrical supply box of claim 1, wherein the cover includes a cover recess, and wherein the switch assembly is received within the cover recess.

8. The electrical supply box of claim 1, wherein the electrical connection of the plurality of outgoing wires to the switch assembly is made using one of a terminal strip, wire nuts, quick connect electrical connectors, or lever nut connectors.

9. The electrical supply box of claim 1, wherein the power inlet fitting is integral to the housing.

10. The electrical supply box of claim 1, wherein the nipple is integral to the housing.

11. A method of installing an electrical supply box on a furnace, comprising:
creating a hole through a wall of the furnace;
aligning a preassembled electrical supply box with the hole, the preassembled electrical supply box including a housing with a movable cover, a switch assembly, a power inlet fitting on the housing, a nipple on the housing, and a plurality of outgoing wires electrically connected within the housing and extending exteriorly through the nipple, the plurality of outgoing wires including a load wire, a neutral wire, and a ground wire;
inserting the nipple through the hole in the wall of the furnace to position an end of each of the plurality of outgoing wires interior to the furnace;
securing the electrical supply box to the wall of the furnace;
securing an incoming power cable to the power inlet fitting on the housing;
electrically connecting wires from the incoming power cable to internal wiring of the electrical supply box; and
electrically connecting the ends of the plurality of outgoing wires to wiring of the furnace.

12. The method of claim 11, wherein securing the electrical supply box to the wall of the furnace includes threading a locknut onto an outer threaded surface of the nipple positioned within an interior of the furnace.

13. The method of claim 12, further comprising:
securing the electrical supply box to the wall of the furnace using adhesive on an exterior surface of the housing prior to threading the locknut.

14. The method of claim 11, wherein electrically connecting wires from the incoming power cable to internal wiring of the electrical supply box includes connecting a source hot wire, a source neutral wire, and a source ground wire to a terminal strip or quick connect electrical connectors within a housing interior of the electrical supply box.

15. The method of claim 11, wherein the power inlet fitting and the nipple are integral to the housing of the preassembled electrical supply box.

16. A system for providing electrical power to a furnace, comprising:
an electrical supply box comprising:
a housing including a plurality of walls defining a housing interior;
a cover attached to the housing and movable with respect to the housing to allow access to the housing interior;
a switch assembly positioned on the cover and including a switch accessible from outside of the housing;
a power inlet fitting positioned on one of the plurality of walls of the housing and aligned with a power inlet fitting opening defined through the housing;
a nipple positioned on one of the plurality of walls of the housing and aligned with a nipple opening defined through the housing; and
a plurality of outgoing wires including a load wire, a neutral wire, and a ground wire, at least a portion of each of the plurality of outgoing wires positioned within the housing interior and pre-electrically connected to the switch assembly, the plurality of outgoing wires insertable through the nipple;
an incoming power cable secured to the power inlet fitting and electrically connected to a power source exterior to the housing; and
a furnace having a wall with an opening receiving the nipple, wherein ends of the plurality of outgoing wires exterior to the housing are electrically connected to furnace wiring within the furnace.

17. The system of claim 16, wherein the electrical supply box further comprises a terminal strip positioned within the housing interior, and wherein wires from the incoming power cable are electrically connected to the terminal strip.

18. The system of claim 16, wherein the nipple includes an outer threaded surface, and wherein the electrical supply box is secured to the wall of the furnace by threading a locknut onto the outer threaded surface of the nipple when the nipple is received in the opening in the furnace.

19. The system of claim 16, wherein the power inlet fitting is integral to the housing.

20. The system of claim 16, wherein the nipple is integral to the housing.
